(19) United States
(12) Patent Application Publication
(10) Pub. No.: US 2023/0212817 A1
(43) Pub. Date: Jul. 6, 2023

(54) METHOD FOR PRODUCING A FABRIC IMPREGNATED WITH A BINDER COMPOSITION

(71) Applicant: CARGILL, INCORPORATED, Wayzata, MN (US)

(72) Inventors: Thomas LUCHSINGER, Hamburg (DE); Dogan Sahin SIVASLIGIL, Overijse (BE)

(73) Assignee: CARGILL, INCORPORATED, Wayzata, MN (US)

(21) Appl. No.: 17/998,223

(22) PCT Filed: May 26, 2021
(86) PCT No.: PCT/US2021/034266

§ 371 Date: Nov. 8, 2022

(30) Foreign Application Priority Data
May 31, 2020 (EP) 20177634.1
Jul. 6, 2020 (EP) 20184186.3

(51) Int. Cl. D06M 15/11; E04D 5/02; D04H 1/587; D04H 1/435

(52) U.S. Cl. CPC D06M 15/11; E04D 5/02; D04H 1/587; D04H 1/435; D06M 2101/32

(57) ABSTRACT

The present invention relates to a method of producing a fabric impregnated with an aqueous binder composition of thinned starch and optionally non-thinned starch. In one aspect, such a method includes providing an aqueous binder composition; providing a fabric, applying an aqueous binder composition to the fabric; and drying the fabric. The invention also relates to the fabric obtained and the use thereof in bituminous membrane layer.

### CROSS-REFERENCE TO RELATED APPLICATIONS

This application claims the benefit of European Application No. 20177634.1, filed May 31, 2020, and European Application No. 20184186.3, filed Jul. 6, 2020, each of which is incorporated by reference herein in its entirety.

### BACKGROUND

The present invention relates to a method of producing a fabric impregnated with a binder composition, the impregnated fabric obtained with such a method, the use of such an impregnated fabric and a bituminous membrane support comprising the impregnated fabric.

Fabrics are often used in building applications, in particular as intermediate layers in sheets and membranes. In such applications, it is important that the fabrics have sufficient mechanical properties, in particular dimensional stability. It is desirable that these mechanical properties are maintained during most of the lifetime of the products they are used in, under all conditions of use, in particular thermal and mechanical stresses.

However, fabrics often do not have sufficient inherent strength and therefore, a binder composition is typically applied on the fabrics. Such binders are usually synthetic binders. The drawback of synthetic binders is that they may release formaldehyde over time. Due to increasingly stringent environmental regulations in building applications, replacements have been sought for synthetic binders that should provide similar or even better mechanical properties, release little or no formaldehyde during their utilization, while being commercially attractive.

EP2231917 describes the use of an aqueous dispersion of polymerisates based on conjugated aliphatic dienes and vinyl aromatic compounds in combination with starch as a binder system for a textile fabric that can be used as a base interlining in sarking, roofing and sealing membranes.

WO2013057086 describes a binder composition for nonwoven fabrics consisting of an aqueous (modified) native starch-based solution, a crosslinking agent of natural origin (e.g. a polycarboxylic acid) and a catalyst (e.g. sodium hypophosphite). The nonwoven fabrics treated with this binder composition are used as supports in bituminous membranes. PROBLEM STATEMENT AND OBJECT OF THE INVENTION

Although the prior art binder compositions provide a formaldehyde free binder for fabrics for building applications, there is still room for improvement, e.g. the mechanical properties of the fabrics impregnated with such binder compositions can be optimized and the efficiency of the manufacturing processes can be improved.

It is an object of the present invention to provide an impregnated fabric having good mechanical properties. It is a further object of the present invention to provide an efficient process for preparing an impregnated fabric. It is a further object of the present invention to provide a process for preparing an impregnated fabric that is in conformity with current environmental requirements.

### BRIEF DESCRIPTION OF THE DRAWING

FIG. 1 shows that the surface temperature of the fabric remains under 200° C.

### INVENTION

The present invention thus provides in a first aspect a method of producing a fabric impregnated with a binder composition, comprising the steps of:

(a) providing an aqueous binder composition;

(b) providing a fabric;

(c) applying the aqueous binder composition to the fabric to wet-impregnate the fabric;

(d) drying the wet-impregnated fabric obtained in step (c);

wherein the aqueous binder composition comprises a thinned starch and wherein the aqueous binder composition has a pH of from 9 to 12.

By using the method of the invention, an impregnated fabric is obtained that can be used in building applications, in particular as part of a bituminous membranes typically used in roofing applications. The impregnated fabric has good mechanical properties, is obtained with an efficient process and is in conformity with current environmental requirements.

In a second aspect, the invention relates to a fabric impregnated with a binder composition, wherein the binder composition comprises a thinned starch and optionally a non-thinned starch; wherein the binder composition comprises 90-100 wt. % of the thinned starch and optionally the non-thinned starch based on the total dry weight of the binder composition and wherein the binder composition has a pH of from 9 to 12.

In a third aspect, the invention relates to the use of an impregnated fabric as a layer in sheets or membranes for construction, preferably in roofing or flooring.

In a fourth aspect, the invention relates to a bituminous membrane support comprising an impregnated fabric according to the invention and a bituminous compound.

### Starches

As described above, the present invention uses a binder composition comprising thinned starch. Preferably, the binder composition also comprises a non-thinned starch. The weight ratio of thinned starch/non-thinned starch is in particular from 50/50 to 99/1.

Mixtures of thinned and non-thinned starch are known, for instance from EP2561137. However, those mixtures are optimized for applications in the paper industry and are not designed for optimizing the mechanical properties of fabrics.

The term “thinned starch”, as used herein, refers to starch polymer molecules that have been degraded through hydrolysis. The hydrolysis results in molecules with a lower molecular weight and a lower viscosity potential than the corresponding non-degraded starch molecules.

As will be known to a person skilled in the art, a thinned starch can be produced in a number of ways, including thinning by using acid (acid thinning), enzymes (enzymatic thinning), oxidizing agents (hydrogen peroxide thinning, hypochloride thinning, persulfate thinning) and heat (thermal degradation).

Preferably, the thinned starch of the present invention is obtained by thermal degradation. Thermal degradation is achieved by heat treating starch molecules under low moisture conditions (i.e. no more than 25% moisture).

Preferably, the thinned starch is a dextrin.

By dextrin is herein understood a depolymerized starch prepared by hydrolysis using acid, heat or enzymes. Preferably, the dextrin used in accordance with the present invention is prepared by depolymerizing the starch with a low moisture thermal treatment. An example of such treatment is disclosed in EP 1 685 162 A1.

The thinned starch may be obtained from native starch (thinned native starch) or from previously modified starch (thinned modified starch), as described hereafter, but is preferably obtained from native starch.

Optionally, the thinned starch is further modified after thinning (modified thinned starch). The term “modified starch”, as used herein, refers to a starch whose structure has been altered by chemical, enzymatic or physical (e.g. heat) treatment. It may include, for instance, esterified starches (such as acetylated or nOSA starches), etherified starches (such as hydroxypropylated or hydroxyethylated starches), cationic starches, cross-linked starches, oxidized starches and mixtures of two or more thereof. It may also include starches which have been subjected to two or more such modifications (e.g. cationic cross-linked starches).

A low level of modification can improve the visco-stability of the binder composition or can improve the interaction of the (aqueous) binder composition with the fabric. With visco-stability is meant that the viscosity of the binder composition does not substantially change over time. However, the level of modification should not be too high because it could negatively impact the mechanical properties of the impregnated fabric.

The degree of modification can be determined by methods known in the art, depending on the type of modification. For example, cationic modification is determined by the increased nitrogen content. whereas esterified starches can determined by caustic hydrolysis and titration. See for instance, “Modified starches: Properties and Uses”, Edited by O. B. Wurzburg, CRC Press, Boca Raton, Fla., 1986 and “Starch: Chemistry and Technology”, Roy L. Whistler, James N. BeMiller, Eugene F. Paschall.

The degree of modification in the modified thinned starch, expressed as the number of hydroxyl groups substituted per glucose unit (degree of substitution), is in particular below 0.1. Thus, for example, the thinned starch of the invention includes a substituted dextrin such as a cationic dextrin, preferably having a degree of substitution of less than 0.1.

The thinned starch of the present invention may be produced from starch of any type and of any origin. Preferably, however, it is produced from wheat starch, corn starch or mixtures thereof. According to a preferred embodiment of the present invention, the thinned starch is a wheat dextrin or corn dextrin, most preferably a corn dextrin.

Thinned starches suitable for use in the present invention will preferably have a Brookfield viscosity in the range of 10 to 10,000 mPa·s, more preferably of 10 to 5000 mPa·s, more preferably of 15 to 1000 mPa·s, more preferably of 20 to 500 mPa·s, more preferably 50 to 300 mPa·s (measured by Method 1).

The term “non-thinned starch”, as used herein, refers to any starch molecule that has not been substantially degraded by hydrolysis, in particular a native starch (non-thinned native starch). The non-thinned starch of the present invention may be starch of any origin. For example, it may be corn starch, potato starch, wheat starch, pea starch, or a mixture of two or more thereof. The non-thinned starch can be a native starch or waxy starch.

Preferably, the non-thinned starch is selected from native corn starch, native potato starch, waxy starch and mixtures thereof. A waxy starch is a starch that contains more than 90% amylopectin molecules. Waxy starches suitable for use in the present invention include waxy corn starch, waxy wheat starch and waxy potato starch.

The non-thinned starch can be modified as described above (non-thinned modified starch).

Preferably, the non-thinned starch is a native starch, more preferably a native corn starch.

In an embodiment, the aqueous binder composition comprises a dextrin and a native starch.

### Aqueous Binder Composition

The term “aqueous binder composition” as used herein, refers to an aqueous composition of the thinned starch and optionally the non-thinned starch according to the present invention, which is used in the impregnation step. The term “binder composition” as used herein, refers to the binder composition after impregnation and drying, in other words, what remains in the fabric after the process according to the present invention.

As described above, the method of the invention comprises applying an aqueous binder composition to the fabric to wet-impregnate the fabric. This aqueous binder composition comprises thinned starch, optionally non-thinned starch and water. The concentration of thinned starch and optionally non-thinned starch in the aqueous binder composition is from 10 to 40 wt. % based on the total weight of the aqueous binder composition. This concentration refers to the combined weight of the thinned starch and the non-thinned starch. It is also referred to as the % dry substance or dry solids. It can be determined using methods known in the art, for instance by IR balance, a microwave or oven method or based on added ingredients. A measurement is described hereafter as Method 2.

The aqueous binder composition comprises water in an amount of preferably at least 40 wt. %, more preferably at least 50 wt. %, most preferably at least 60 wt. %, relative to the total weight of said composition. Preferably, the amount of water in the aqueous binder composition is at most 90 wt. %, more preferably at most 85 wt. %, based on the total weight of the aqueous binder composition.

The effect of the use of thinned and optionally non-thinned starches according to the present invention is that it provides sufficiently binding strength which cannot be obtained by either of the starches alone. This has the advantage that no or only minor amounts of further reactive agents such as cross-linkers and catalysts, are necessary to obtain sufficiently strong impregnated fabrics, thereby reducing or even completely eliminating the need for these compounds and their effect on the cost and environmental issues. Preferably, the aqueous binder composition is free of a cross-linking agent, wherein by cross-linking agent is herein understood an agent which can form intermolecular linkages, i.e. covalent and/or ionic linkages, between the starch molecules. By free of a cross-linking agent is herein understood that said composition contains at most 5000 ppm of the cross-linking agent, more preferably at most 2000 ppm, most preferably at most 1000 ppm, based on the weight of the aqueous binder composition.

The binder composition of the present invention may contain useful additives needed to increase preservation, properties as well as processability of the composition, such as plasticizers (e.g. urea, sorbitol, glycerol), surface active agents, preservatives, stabilizers, anti-oxidants, antifoaming agents, waterproofing agents, UV stabilizers, fillers and pigments. In an embodiment, the total amount of additives present in the binder composition (calculated on the dry weight of the binder composition—with no water present) is at most 10 wt. %, preferably at most 5 wt. %, such as at most 2 wt. % or 1 wt. %. It may also be free of additives.

Based on the dry weight of the binder composition (no water present), the composition contains 90-100 wt. % combined thinned and non-thinned starch, such as at least 90 wt. %, preferably at least 95 wt. % or even at least 98 wt. % or 99 wt. % of combined thinned and non-thinned starch.

For ease of application, the viscosity of the aqueous binder composition should at least 10 mPa·s. Preferably the viscosity of the aqueous binder composition is less than 1200 mPa·s, more preferably less than 1000 mPa·s as measured by Method 1. The viscosity can readily be adjusted by a person skilled in the art by varying the ratios between thinned and non-thinned starch and/or the starch concentration in the aqueous binder composition and/or by varying the temperature of the aqueous binder composition during the impregnation step.

### Process for Preparing the Aqueous Binder Composition

As described above, the present method includes a step (a) of providing an aqueous binder composition comprising thinned starch, optionally non-thinned starch and water.

Preferably, this step includes solubilizing the thinned starch, non-thinned starch or both, such that they are water soluble, preferably cold water soluble. For reference, solubility as used herein generally refers to the fact that the starch granules are able to swell, forming a viscous, colloidal dispersion. Thus, (cold) water soluble starches may also be referred to as “(cold) water swellable” starches.

The thinned starch and non-thinned starch may be solubilized separately and then mixed, or the mixture of thinned starch and non-thinned starch may be solubilized.

Solubilization may be achieved, for instance, by cooking, heat treatment and/or pre-gelatinization. For cooking, the starch can be suspended in water at around 10-35 wt. %., depending on the desired properties, such as viscosity, to be obtained. Cooking may be performed for example in batch at about 95-100° C. or by jet-cooking at a pressure of about 0.6-0.8 MPa at about 120° C.-140° C. After cooking, the starch mixture is cooled to a temperature below 50° C. The particular cooking conditions to be used will readily be determined by a person skilled in the art based on the type and quantity of starch to be solubilized and on the required degree of solubility to be obtained.

The resulting starch mixture preferably has a solubility, measured according to Method 3 set out below, of at least 50%, more preferably of at least 75%, most preferably of at least 80%.

As an alternative to the solubilization described above, (dried) pre-gelatinized starches can be used. Such starches are known to the person skilled in the art.

The aqueous binder composition can be prepared as a starch dispersion. The process for preparing the starch dispersion comprises the following steps:
i. providing a thinned starch and optionally a non-thinned starch;
   optionally solubilizing the thinned starch, the non-thinned starch or both;
ii. mixing the thinned starch and optionally the non-thinned starch with water, creating a starch dispersion;
iii. adjusting the pH of the starch dispersion to a value of from 9 to 12.

As an alternative, it is also possible to adjust the pH during solubilization of the starch and optionally non-thinned starch.

The aqueous binder composition preferably has a pH value of at least 9, more preferably at least 10, most preferably at least 11 Preferably, the pH of the aqueous binder composition is at most 12. Preferably, said pH is between 10 and 12, more preferably between 11 and 12, e.g. about 11.5.

The pH of the aqueous binder composition can be adjusted by well-known means, e.g. by adding a base (or an alkali), preferably a food grade base or by using a pH buffer solution. A buffer solution (more precisely, pH buffer or hydrogen ion buffer) is an aqueous solution consisting of a mixture of a weak acid and its conjugate base, or vice versa. Its pH changes very little when a small amount of strong acid or base is added to it. Buffer solutions are used as a means of keeping pH at a nearly constant value in a wide variety of applications, e.g. food, personal care and pharma applications. Preferably, a food grade base is utilized to adjust the pH of the aqueous environment, non-limiting examples thereof including ammonium hydroxide or aqueous ammonia, sodium hydroxide, sodium bicarbonate, potassium hydroxide, potassium carbonate and calcium hydroxide, quicklime/calcium oxide, calcium carbonate, and mixtures thereof. The pH can be measured with any pH-meter known in the art after carrying out its calibration (if required) and using it as indicated in the operating instructions.

Without wishing to be bound to any theory, it is believed that at this pH of the aqueous binder composition the starches show better penetration in the fabric. Moreover, retrogradation of the starch is slowed down.

According to one embodiment, the aqueous binder solution is used as such to wet-impregnate the fabric. According to another embodiment it is also possible to dry the aqueous binder composition for storage and/or shipment. The dried binder composition can then be reconstituted in water (step (a) of the present method, to carry out step (c) of the present method.

### Fabric

The fabric to be treated according to the invention is a fabric that can be knitted, woven or nonwoven (felt). The fabric can comprise natural fibers, such as cotton, linen, sisal, jute, hemp, coconut, inorganic fibers, such as glass, ceramic, rock and metal fibers and of synthetic fibers, such as polyamide, polypropylene, polylactic acid, polyphenylenesulfide, polyethyleneimide, polyoxymethylene and polyester fibers.

The present method is particularly suitable for fabrics of synthetic fibers, in particular polyester fibers, such as polyethylene terephthalate (PET).

The fabric is preferably a nonwoven fabric. Nonwoven fabrics (or felt) are broadly defined as sheet or web structures bonded together by entangling fiber and/or filaments mechanically, thermally or chemically. In case of synthetic fibers, the fibers can be spun-bonded or staple fibers. Spunbonded fabrics are manufactured by random deposition of freshly melt-spun filaments and binding of filaments. Binding can be physical (in melt), chemical (with a binding agent) or mechanical (needling).

The fabric of synthetic fibers can further contain reinforcing fibers, e.g. glass fibers, rock fibers and/or metal fibers. The fabric can contain further additives known in the art such as flame retardants and fillers.

The fabric can be a single layer or multilayer fabric. In case of a multilayer fabric, each layer can have the same or a different composition.

Generally the fabric has a thickness of 0.01 to 5 mm. The weight per unit area of the fabric is from 20 to 500 g/m².

### Process for Wet-Impregnating Fabric

In step (c) of the method according to the invention, the aqueous binder composition is applied to the fabric. This step is carried out such that the fabric is wet-impregnated with the aqueous binder composition.

With “wet-impregnated” is meant that the aqueous binder composition is spread on one or both sides of the fabric and through the fabric. Thus, the result is that the aqueous binder composition is present on and in between the fibers that make up the fabric.

For this step, known methods for impregnating textile fabrics with a liquid can be used, e.g. with nip rolls, such as a textile padder or dip impregnation using a bath of the aqueous binder composition.

The aqueous binder composition is preferably at a temperature of from 20 to 60° C.

In an illustrative process, the fabric is fed via rolls through a container containing the aqueous binder composition, or the aqueous binder composition is fed to the nip between the rolls. The rolls can be heated, e.g. to a temperature of 20 to 50° C. Also, the pressure between the rolls can be adjusted, as well as the roll speed. By varying these different parameters, the amount of aqueous binder composition that is taken up by the fabric can be determined.

Preferably, the amount of aqueous binder applied to the fabric is 100 to 250% (Wet Add-on) of the weight of the (initial) fabric, i.e. the fabric provided in step (b) of the process. Wet Add-on can be determined according to Method 4.

Step (c) of applying the aqueous binder composition is followed by a drying step (d). This drying step can be carried out in a continuous manner by moving the fabric through hot air, e.g. in a ventilated oven, following the impregnation of the fabric. The drying can also be carried out separately in an oven.

Drying is for instance carried out at a temperature of 50 to 250° C. In particular the surface temperature of the fabric should remain below 200° C., preferably below 170° C., most preferably below 150° C. In an embodiment, the surface temperature of the fabric in step (d) is from 100 to 150° C.

Drying conditions can be monitored by measuring the surface temperature of the fabric, e.g. by using a temperature probe.

The drying time (duration of step (d)) can be readily adjusted by a person skilled in the art. For instance, the drying time is from 0.5 to 180 minutes.

The aim of step (d) is to obtain an efficient drying process while avoiding degradation of the starch.

To evaluate the mechanical properties of the fabric in controlled conditions, the drying can be followed by an equilibration step in a controlled climate, for instance, for 24 hours at 23° C. at 50% relative humidity.

The present invention also provides a method of producing a fabric impregnated with a binder composition, comprising the steps of:

(a) providing an aqueous binder composition;

(b) providing a fabric;

(c) applying the aqueous binder composition to the fabric to wet-impregnate the fabric;

(d) drying the wet-impregnated fabric obtained in step (c);

wherein the aqueous binder composition comprises a thinned starch and wherein the aqueous binder composition has a pH of from 9 to 12;
wherein in step (d) the drying comprises two drying steps, a first drying step carried out at a first temperature of between 150 and 250° C., preferably between 175 and 220° C., preferably for a first drying time of between 0.5 minutes and 20 minutes, more preferably between 1 minute and 5 minutes and a subsequent second drying step carried out at a second temperature of between 50 and 130° C., preferably between 75 and 120° C., preferably for a second drying time of between 10 minutes and 90 minutes, more preferably between 30 minutes and 60 minutes. Herein, by drying temperature is meant the temperature of the equipment utilized to carry out the drying of the fabric, e.g. a dryer or an oven. The preferred equipment for drying the fabric is the dryer.

Preferably the first temperature is between 175 and 220° C. and the second temperature is between 75 and 120° C., wherein preferably the first drying time is between 1 minute and 5 minutes and the second drying time is between 30 minutes and 60 minutes.

### Impregnated Fabric

The present invention also relates to the impregnated fabric obtained with the method of the present invention.

According to a further aspect the present invention thus also provides a fabric in that it is impregnated with a binder composition comprising thinned starch and optionally non-thinned starch, wherein the binder composition comprises 90-100 wt. % of the thinned starch and optionally the non-thinned starch based on the total dry weight of the binder composition and wherein the binder composition has a pH of from 9 to 12.

The binder composition preferably has a pH from 10 to 12, more preferable from 11 to 12, in particular about 11.5. Preferably, the binder composition comprises both thinned starch and non-thinned starch. The weight ratio of thinned starch/non-thinned starch in the binder composition is preferably from 50/50 to 99/1.

As described above, the binder composition contains no or only minor amounts of further reactive agents such as cross-linkers and catalysts. In particular, the binder composition contains at most 5000 ppm of the cross-linking agent, more preferably at most 2000 ppm, most preferably at most 1000 ppm, based on the weight of the binder composition.

With “impregnated” is meant that the binder composition is present on and in between the fibers. In contrast to the “wet-impregnated” fabric described above, there is little water present. Thus, the binder composition comprised in the impregnated fabric contains little water since it has been obtained after the drying step (d), e.g. less than 30 wt. %, preferably less than 20 wt. %, based on the total weight of the binder composition. Due to hygroscopic properties of starch, the equilibrium water content of the binder composition can be from 5 to 20 wt. %.

The thinned starch and non-thinned starch in the binder composition of the impregnated fabric are as defined above.

According to a preferred embodiment of the present invention, the thinned starch is dextrin, in particular a wheat dextrin or corn dextrin, most preferably a corn dextrin.

According to a further preferred embodiment, the non-thinned starch is selected from native corn starch, native potato starch, waxy starch and mixtures thereof, preferably a native corn starch.

Thus, in an embodiment, the binder composition comprises a dextrin and a native starch.

The resulting impregnated fabric contains an amount of binding composition of 5-35% Dry Add-on, as calculated according to Method 4.

The use of the binder composition of the invention results in improved mechanical properties and dimensional stability compared to the initial fabric that is treated. These properties can be expressed as improvements in for instance tensile strength and elongation.

The impregnated fabric preferably has a maximum elongation of less than 50%, preferably less than 40%, or even less than 30% at 25° C.

### Use

The impregnated fabric obtained according to the invention can be used in building applications, for instance in building membranes for roofing and flooring. The impregnated fabric is particularly suitable for bituminous applications.

The invention thus also relates to a bituminous membrane support comprising an impregnated fabric according to the invention and a bituminous compound. The impregnated fabric will generally constitute 1 to 40 wt % of the bituminous membrane support.

The bituminous membrane support may include one or more further layers beside the bitumen layer and the impregnated fabric, including further textile layers, layers of reinforcing fibers (glass or mineral fibers), layers of thermoplastic fibers, thermoplastic elastomer layers (EPDM), etc.

### Experimental

### General Methods

### Fabric Sample Preparation

Fabric sheets are cut from a fabric roll with the following dimensions or else as suitable:
a) 260 mm×320 mm
b) 325 mm×425 mm
The dry weight of the prepared specimens is recorded. Due to the significant inhomogeneity of the base fabric, series of comparable dry weight need to be preselected before starting a trial series. Specimens from the edge of the rolls shall be avoided.

### Binder Preparation

The binder composition is prepared according to the specific binder recipe of the trials to be done. A starch slurry is prepared by dispersing the dry starch powder in water at the required dry solid content. In case of not previously pregelatinized starch, the starch granules need to be solubilized by cooking. This is preferably done by a jet cooking process for starch preparation. Here applied conditions for jet cooking were 130° C. and a holding time of 1.5 minutes.

The binder is then cooled down below 60° C. Dry solids are measured and adjusted precisely to the target level. In case of pH adjustment, NaOH is added to the binder composition just before application to the fabric.

### Fabric Impregnation

A horizontal, vertical padder type HVF (Mathis AG, Oberhasli Switzerland) is used for the impregnation of fabrics. Optionally, the rolls of the padder are pre-heated using e.g. a Regloplus SMART P140 device to the required impregnation temperature. 25° C. or 50° C. for higher viscous binder composition have been proven to be good temperature levels for impregnation. For safety reasons, a temperature of 60° C. should not be exceeded for the rolls.

Aqueous binder composition is added to the nip between the rolls of the padder. The pre-weighted fabric specimen is inserted in machine direction from the top into the bath that contains the aqueous binder composition between the rolls.

The sheet is then pulled through the rolls and excess binder is removed by pressure application of the rolls.
Binder composition add-on in these experiments can be controlled with the 3 following parameters:
Roll pressure (typical values are 1-3 bar)
Roll speed (typical values are 1-3 m/s)
Aqueous binder composition dry solids (10-15% d.s.)
   The weight of the wet fabric is recorded for calculation of the Wet binder Add-on.

### Fabric Drying

Curing or drying of the wet impregnated nonwoven fabrics is done in a lab textile dryer Typ LTE (Mathis AG). The wet fabric is fixed on a needle frame with slight tension applied in order to avoid shrinkage during drying. Time, temperature and ventilation are adjusted according to the intended drying process per fabric.

After drying the impregnated fabric is conditioned at 23° C. and 50% relative humidity (r.h.) and then transferred to a balance in order to record the dried weight.

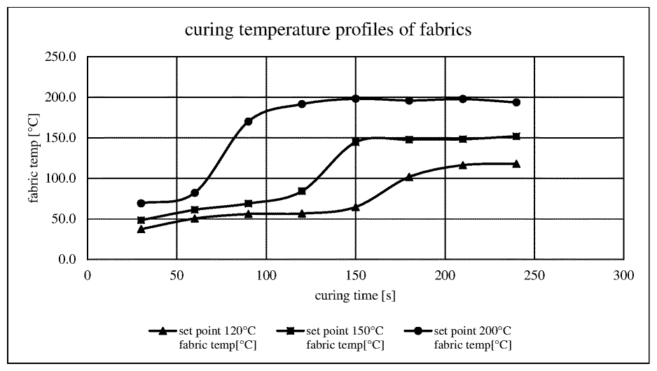

FIG. 1 shows that the surface temperature of the fabric remains under 200° C.

### Test Methods and Calculations

Method 1 Brookfield viscosity

Principle: a 44% dry basis slurry of the starch material to be tested is made at 25° C. When fully dispersed, a Brookfield viscosity measurement is made.

Method: 110 g (dry basis) of the starch material to be tested is added to a normalized 400 ml glass beaker together with demineralized water to a total weight of 250 g. The composition is then gently mixed with a stirring spatula, avoiding the inclusion of air bubbles. The viscosity of the obtained slurry is measured using a Brookfield RV viscometer, following the manufacturer's instructions.

Viscosity is measured in mPa·s with a number 2 spindle at 100 rpm (note: if the viscosity is above the scale maximum (400 mPa·s) the test can be repeated using a number 3 spindle at 100 rpm).

### Method 2 Dry Substance

The moisture content of a sample is determined with an infrared moisture balance (MA30, Sartorius). The sample is dried at 105° C. The moisture content (in wt %) is calculated as (A1−A2)/A1×100 where A1 was the weight of the sample before drying in the oven and A2 was the weight of the resulted dried sample. Dry substance content (DSC) is measured according to formula: DSC (%)=100%−MC (%)

### Method 3 Solubility

The percent dry substance (DS) of a sample is determined by drying 5 g for 4 hours at 120° C. under vacuum. 2 g of sample is weighed and transferred to a dry 200 ml Kohlrausch flask. The flask is partially filled with water at 25° C. and shaken vigorously until completely in suspension and diluted to volume. The flask is stoppered and shaken gently while submerged in a water bath at 25° C. for a total agitation time of 1 hour. The samples is filtered through a Whatman No. 2V paper, the first portion of filtrate is returned. 50 ml of filtrate is transferred to a weighed evaporating dish. The sample is evaporated to dryness on a steam bath and dried in a vacuum oven for 1 hour at 100° C. The sample is cooled in a desiccator and weighed to the nearest mg.

DS[%]=100−[(loss in weight, g×100)/(sample weight, g)]

Solubles[%]=(residue weight, g×100)/[0.25×sample weight, g×(DS, %/100)]

### Method 4 Wet Binder Add-on and Dry Binder Add-on

The initial fabric is weighed before impregnation treatment. The wet-impregnated fabric is transferred to a balance to record the wet weight. The Wet Add-on is calculated as follows:

Wet Add-on [%]=(Wet−Impregnated Fabric [g]−Initial Fabric [g])/Initial Fabric [g]*100

Dry Add-on [%]=(Dried Fabric [g]−Initial Fabric [g])/Initial Fabric [g]*100

### Mechanical Testing

Mechanical testing of (dried) samples of the impregnated fabric is done with a Zwick Tensile Testing machine (or similar). Samples of dimensions 210 mm×50 mm are cut from the dried sheet, whereas samples from the border of the sheet must be avoided. In case of glass fibre reinforced fabric, it is important to make sure that always the same amount of glass fibre elements are present in the test specimen.

The tensile measurement is performed under following test parameters:
Grip to grip separation at the start position: 140 mm
Preload: 1 N
Preload velocity: 5 mm/min
Measurement velocity: 40 mm/min

Break Investigation:
Number of captures for break detection: 50
Force jump: 5%
Negative strain transition: 10%
Positive strain transition: 10%

End of Test:
Force shutdown threshold: 90% FMax
Force threshold for break investigation: 0.1% Fnom
Stress strain curves were described by 2 key values Fmax and Strain at break

The following mechanical parameters are recorded:
Fmax in machine direction [N/5 cm]
Fmax in cross direction [N/5 cm]
Tenacity [(daN/5 cm)/(g/m2)]
Elongation dL at Fmax [mm]

### EXAMPLES

### Materials

### Fabric:

Spunbonded non-woven based on polyethylene terephthalate (PET), reinforced with glass fibres in longitudinal direction, with weight per area unit of 180 g/m². PET staple fibres based non-woven, carded, reinforced with glass fibres in longitudinal direction, 175 g/m²

### Starch:

C*Film 07324—thinned starch, corn dextrin
C*Film 07325—thinned starch, corn dextrin
C*Size 03453—native corn starch (non-thinned)
C*Gel 04201—native waxy corn starch (non-thinned)
NaOH to adjust pH of the binder composition

Synthetic binder composition: As a comparative Example, a known synthetic binder composition is used.

### Example 1

Objective: demonstrate impact of drying conditions and binder pH on performance of final nonwoven

Fabric: PET staple fibres based non-woven, carded, reinforced with glass fibres in longitudinal direction, 175 g/m²

| | Compar- | | | |
|---|---|---|---|---|
| | ative | Example | Example | Example |
| | Example | 1.1 | 1.2 | 1.3 |
| Binder Composition | | | | |
| Synthetic Binder | 100 | 0 | 0 | 0 |
| Composition | | | | |
| C*Film 07324 | 0 | 50 | 50 | 50 |
| C*Size 03453 | 0 | 50 | 50 | 50 |
| Binder pH | 7.5 | 11.5 | 11.5 | 7.0 |
| Drying conditions: | 4 min at | 4 min at | 1 min at | 1 min at |
| | 200° C. | 200° C. | 200° C. | 200° C. |
| | | | predrying | predrying |
| | | | 45 min at | 45 min at |
| | | | 100° C. | 100° C. |
| Dry binder add on | 20.55 | 22.28 | 22.66 | 22.15 |
| [%] | | | | |
| Tensile Strength | 394.3 | 336.7 | 371 | 357 |
| longitudinal max | | | | |
| MD [N/5 cm] | | | | |
| Elongation at max | 27.1 | 31.1 | 27.2 | 29 |
| Tensile Strength | | | | |
| longitudinal MD | | | | |
| [mm] | | | | |
| Tenacity [max] | 0.212 | 0.176 | 0.193 | 0.188 |
| [(daN/5 cm)/(g/m²)] | | | | |

### Example 2

Objective: Impact of binder composition and binder pH on performance of final nonwoven

Fabric: Spunbonded non-woven based on polyethylene terephthalate, reinforced with glass fibres in longitudinal direction, with weight per area unit of 180 g/m²

| | Comparative | Example | Example | Example | Example |
|---|---|---|---|---|---|
| | Example | 2.1 | 2.2 | 2.3 | 2.4 |
| Binder Composition | | | | | |
| Synthetic Binder Composition | 100 | 0 | 0 | 0 | 0 |
| C*Film 07324 | 0 | 100 | 100 | 0 | 0 |
| C*Film 07325 | 0 | 0 | 0 | 90 | 90 |
| C*Gel 04201 | 0 | 0 | 0 | 10 | 10 |
| Binder pH | 7.6 | 7.0 | 11.5 | 7.0 | 11.5 |
| Drying conditions: | 4 min at | 1 min at | 1 min at | 1 min at | 1 min at |
| | 200° C. | 200° C. | 200° C. | 200° C. | 200° C. |
| | | predrying | predrying | predrying | predrying |
| | | 45 min at | 45 min at | 45 min at | 45 min at |
| | | 100° C. | 100° C. | 100° C. | 100° C. |
| Dry binder add on [%] | 20 | 16.26 | 22.78 | 22.02 | 24.4 |
| Tensile Strength longitudinal | 641 | 529 | 625.2 | 525.7 | 607.6 |
| max MD [N/5 cm] | | | | | |
| Elongation at max Tensile | 38.3 | 53.2 | 50.7 | 55.4 | 49.7 |
| Strength longitudinal MD [mm] | | | | | |
| Tenacity [max][(daN/5 cm)/ | 0.282 | 0.233 | 0.261 | 0.225 | 0.254 |
| (g/m²)] | | | | | |

### Example 3

Objective: Impact of binder composition on performance of final nonwoven

Fabric: Spunbonded non-woven based on polyethylene terephthalate, reinforced with glass fibres in longitudinal direction, with weight per area unit of 180 g/m²

| | Example 3.1 | Example 3.2 | Example 3.3 |
|---|---|---|---|
| Binder Composition | | | |
| Synthetic Binder | 0 | 0 | 0 |
| Composition | | | |
| C*Film 07324 | 50 | 100 | 0 |
| C*Size 03453 | 50 | 0 | 0 |
| C*Film 07325 | 0 | 0 | 90 |
| C*Gel 04201 | 0 | 0 | 10 |
| Binder pH | 11.5 | 11.5 | 11.5 |
| Drying conditions: | 1 min at | 1 min at | 1 min at |
| | 200° C. | 200° C. | 200° C. |
| | predrying | predrying | predrying |
| | 45 min at | 45 min at | 45 min at |
| | 100° C. | 100° C. | 100° C. |
| Dry binder add on [%] | 21.55 | 21.15 | 20.90 |
| Tensile Strength | 557.2 | 538.6 | 558.8 |
| longitudinal max MD | | | |
| [N/5 cm] | | | |
| Elongation at max | 40.9 | 45.5 | 41.2 |
| Tensile Strength | | | |
| longitudinal MD [mm] | | | |
| Tenacity [max] | 0.236 | 0.220 | 0.230 |
| [(daN/5 cm)/(g/m²)] | | | |

1. A method of producing a fabric impregnated with a binder composition, comprising the steps of:
(a) providing an aqueous binder composition;
(b) providing a fabric;
(c) applying the aqueous binder composition to the fabric to wet-impregnate the fabric;
(d) drying the wet-impregnated fabric obtained in step (c);
wherein the aqueous binder composition comprises a thinned starch and wherein the aqueous binder composition has a pH from 9 to 12.

2. The method according to claim 1, wherein the pH of the aqueous binder composition is from 10 to 12.

3. The method according to claim 1, wherein the aqueous binder composition further comprises a non-thinned starch and the weight ratio of thinned starch/non-thinned starch in the aqueous binder composition is from 50/50 to 99/1.

4. The method according to claim 1, wherein the thinned starch is a dextrin.

5. The method according to claim 3, wherein the non-thinned starch is selected from native corn starch, native potato starch, and waxy starch.

6. The method according to claim 1, wherein in step (d) the drying of the fabric is carried out such that the surface temperature of the fabric is less than 200° C.

7. The method according to claim 1, wherein the aqueous binder composition contains
10-40 wt. % thinned starch and optionally non-thinned starch
40-90 wt. % water
based on the total weight of the aqueous binder composition.

8. The method according to claim 1, wherein the aqueous binder composition is a starch dispersion and wherein step (a) of providing the aqueous binder composition comprises:
i. providing a thinned starch and optionally a non-thinned starch;
optionally solubilizing the thinned starch, the non-thinned starch or both;
ii. mixing the thinned starch and optionally the non-thinned starch with water, creating a starch dispersion;
iii. adjusting the pH of the starch dispersion to a value from 9 to 12.

9. The method according to claim 1, wherein the fabric is a nonwoven fabric comprising synthetic fibers.

10. The method according to claim 9, wherein the synthetic fibers comprise polyester fibers.

11. The method according to claim 1, wherein in step (c) the aqueous binder composition is brought to a temperature of 20-60° C., prior to contacting the fabric with the aqueous binder composition, and wherein the fabric is contacted with the aqueous binder composition until the fabric is wet-impregnated with an amount of aqueous binder composition that is 100 to 250% (Wet Add-on) of the weight of the fabric.

12. A fabric impregnated with a binder composition,
wherein the binder composition comprises a thinned starch, optionally in combination with a non-thinned starch,
wherein the binder composition comprises 90-100 wt. % of the thinned starch and optionally the non-thinned starch based on the total dry weight of the binder composition and
wherein the binder composition has a pH from 9 to 12.

13. The impregnated fabric according to claim 12, wherein the amount of binder composition is 5 to 35% Dry Add-on of the weight of the fabric.

14. (canceled)

15. Bituminous membrane support comprising a fabric according to claim 12 and a bituminous compound.

16. The method according to claim 4, wherein the thinned starch is corn dextrin.

17. The method according to claim 5, wherein the non-thinned starch is native corn starch.

18. The method according to claim 1, wherein in step (d) the drying of the fabric is carried out such that the surface temperature of the fabric is less than 170° C.

19. The method according to claim 1, wherein in step (d) the drying of the fabric is carried out such that the surface temperature of the fabric is less than 150° C.

20. The method according to claim 9, wherein the synthetic fibers comprise polyethylene terephthalate fibers.

21. The fabric of claim 12, wherein the binder composition has a pH from 10 to 12.
